(19) United States
(12) Patent Application Publication
(10) Pub. No.: US 2018/0287440 A1
(43) Pub. Date: Oct. 4, 2018

(54) PERMANENT MAGNET-TYPE ROTOR AND MANUFACTURING METHOD THEREFOR

(71) Applicant: PIOM MOTER CO., LTD., Seocho-gu Seoul (KR)

(72) Inventor: Mingshan Li, Seocho-gu Seoul (KR)

(73) Assignee: PIOM MOTER CO., LTD., Seocho-gu Seoul (KR)

(21) Appl. No.: 15/766,033

(22) PCT Filed: Aug. 24, 2016
(86) PCT No.: PCT/KR2016/009358

§ 371 Date: Apr. 5, 2018

(30) Foreign Application Priority Data
Oct. 5, 2015 (KR) 10-2015-0139780

(51) Int. Cl. H02K 1/27; H02K 15/03; H02K 21/16

(52) U.S. Cl. CPC H02K 1/276; H02K 21/16; H02K 15/03

(57) ABSTRACT

The present invention relates to a permanent magnet-type rotor and a manufacturing method therefor and, particularly, to a permanent magnet-type rotor and a manufacturing method therefor, the permanent magnet-type rotor comprising: a rotor core coupled to a rotary shaft at the center thereof so as to prevent a slip phenomenon of a permanent magnet, and made of a soft magnetic material; and a plurality of permanent magnets arranged along the outer circumferential surface of the rotor core, wherein the rotor core has a plurality of fixing grooves, which are formed in the lengthwise direction and are arranged at predetermined intervals along the outer circumferential surface, and the permanent magnet is forcedly inserted into the fixing groove and fixed in a form in which both sides of the permanent magnet are encompassed by a jig body made of a non-magnetic material.

### TECHNICAL FIELD

This invention is about a rotor of a permanent magnet type and its manufacturing method, and in particular, about a rotor of a permanent magnet type that prevents a slip phenomenon of a permanent magnet and a manufacturing method that can make a rotor of a permanent magnet type simply.

### BACKGROUND TECHNOLOGY

In general, a rotor is called as a rotator or a body of rotation, and is a generic term for rotating parts of a generator or a motor. A generator of a permanent magnet type generally has a rotator that a permanent magnet is attached in a stator with winding coils, and a current that is generated by rotating a rotator is abandoned, and a motor of a permanent magnet type generally has a rotator that a permanent magnet is attached in a stator with winding coils, and a rotator is rotated by changing stimulus generated between a permanent magnet and a stator by applying different currents on a coil winding on a stator alternatively and it is used as a power.

Like this, a rotator that is applied to a generator of a motor of a permanent magnet type generally has a structure that a permanent magnet is attached and fixed on circumference surface of a rotator core that is made by accumulating thin silicon steel plates in multiple layers, and many methods to attach a permanent magnet to circumference surface of the above rotator core have been suggested.

As shown in FIG. 1 which is one of those methods, while several permanent magnets (30) having the identical radius of curvature are attached at a constant interval towards circumferential direction to circumference surface of the rotator core that is shaped as a cylinder by stratification of multi-layered steel plates so that it can contact closely, each permanent magnet (30) is mutually combined by an adhesive (32), and a binder (34) is attached to the outside of a permanent magnet (30).

However, in case that a permanent magnet is fixed by an adhesive (32) and a binder (34) like this, there is a problem that a permanent magnet (30) is moved between a rotator core (20) and a binder (34) since an adhesive is melted by the heat generated by operation of a rotor, resulting in loss of a function of a rotor since variation of stimuli is not constant.

### RELATED PRECEDENT TECHNOLOGY

Registered Patent Communication #10-0857798 “A Permanent Magnet Rotator Motor and A Manufacturing Method Thereof”

### DETAILED DESCRIPTION OF INVENTION

### Technical Task

This invention is to solve the above problem and is aimed at suggesting a rotor of a permanent magnet type and its manufacturing method that can be made simply without a slip phenomenon of a permanent magnet.

### Methods to Solve the Task

A rotor of a permanent magnet type which is the invention to achieve the above purpose includes a rotator core that a rotating axis is combined and is made of a ferromagnetic body and several permanent magnets that are placed along with the outer circumference of the above rotator core, but as for the above rotator core, several fixing grooves formed along with a longitudinal direction are formed at a certain interval along with the outer circumference, and the above permanent magnet is inserted into a fixing groove forcefully and is characterized by fixing with a type that both sides are wrapped by a body of a jig made of non-magnetic materials.

Besides, a method of manufacturing a rotor of a permanent magnet type which is the invention to achieve the above purpose includes stages that a body of a jig made of non-magnet materials is inserted into the above fixing groove forcefully after being equipped with several rotator cores that a rotating axis is combined at the center and many fixing grooves that are made of a ferromagnetic body and are formed along with a longitudinal direction are formed at a certain interval along with the outer circumference; that they are placed along with the outer circumference of the above rotator core so that both sides are wrapped by the above jig body with being equipped with several permanent magnets.

### Effect of Invention

Since a rotor of a permanent magnet type by the invention makes it possible to combine a permanent magnet with a rotator core without using an adhesive, a slip phenomenon of a permanent magnet by heat generated during operation of a rotor does not occur so the stability of a rotor is high, and it is possible for high-speed rotation accordingly.

In addition, since a permanent-magnet typed rotor that has high safety and is possible for high-speed rotation can be produced through a simple process as for manufacturing a permanent-magnet typed rotor by the invention, the effect of improving productivity can be acquired.

### BRIEF DESCRIPTION OF DRAWINGS

FIG. 1 is an example drawing showing the section of the previous rotor of a permanent magnet type,

FIG. 2 is a perspective view showing a rotor of a permanent magnet type by the invention,

FIG. 3 is a perspective view showing a rotator core that is applied to a rotor of a permanent magnet type by the invention,

FIG. 4 is a perspective view showing a rotating axis that is applied to a rotor of a permanent magnet type by the invention,

FIG. 5 is a perspective view showing a body of a jig that is applied to a rotor of a permanent magnet type by the invention,

FIG. 6 is a perspective view showing a state that a body of a jig is combined with a rotator core that is applied to a rotor of a permanent magnet type by the invention,

FIG. 7 is a perspective view showing a permanent magnet that is applied to a rotor of a permanent magnet type by the invention,

FIG. 8 and FIG. 12 are the drawings showing an example of a rotating plate comprising a rotator core that is applied to a rotor of a permanent magnet type by the invention,

FIG. 13 is a perspective view showing a state that rotating plates comprising a rotator core that is applied to a rotor of a permanent magnet type by the invention are mutually combined by punching,

FIG. 14 is an example drawing showing that a body of a jig is combined with a rotor core that is applied to the permanent-magnet typed rotor by the invention,

FIG. 15 is a perspective view showing a state that jig plates comprising a body of a jig that is applied to the permanent-magnet typed rotor by the invention is accumulated

FIG. 16 is a perspective view showing a protective plate that is applied to the permanent-magnet typed rotor by the invention,

FIG. 17 is a perspective view showing another example of the permanent-magnet typed rotor by the invention.

FIG. 18 is a front view showing other cases of the permanent-magnet typed rotor by the invention

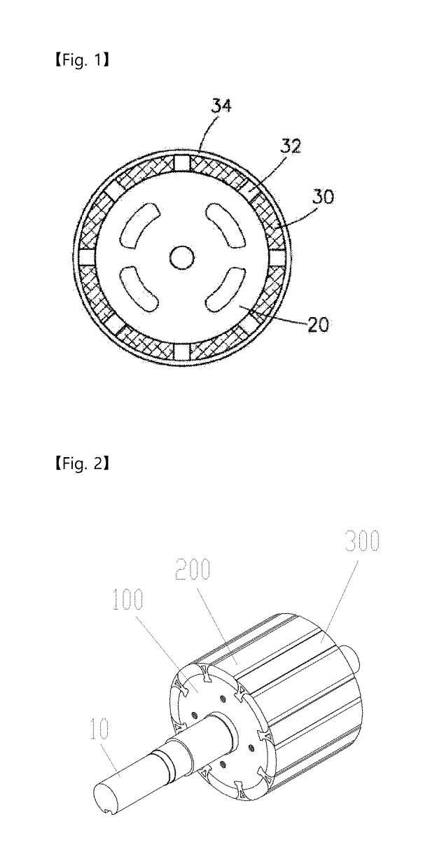

### A TYPE TO IMPLEMENT INVENTION

In the invention, it is to suggest a rotor of a permanent magnet type that includes a rotator core that a rotating axis is combined at the center and is made of a ferromagnetic body not to cause a slip phenomenon and several permanent magnets that are placed along with the outer circumference of the above rotator core, but as for the above rotator core, several fixing grooves that are formed along with a longitudinal direction are formed at a certain interval along with the outer circumference and the above permanent magnet is characterized by being inserted into a fixing groove and by fixing in a type that both sides are wrapped by a body of a jig made of non-magnetic materials.

Besides, in order to make the above rotor of a permanent magnet type simply, it is to suggest a method of manufacturing a rotor of a permanent magnet type including stages that it is combined by inserting a body of a jig made of non-magnetic materials into the above fixing grooves after a rotating axis is combined at the center and it is made of a ferromagnetic body and being equipped with a rotator core that several fixing grooves that are formed along with a longitudinal direction are formed at a certain interval along with the outer circumference, and that several permanent magnets are equipped and placed along with the outer circumference of the above rotator core so that both sides can be wrapped by the above jig body.

The extent of a right of the invention is not limited to examples of implementation that are described as below, and it can be transformed and implemented diversely by the person who has ordinary knowledge on the relevant technical field within the scope that does not deviate from the technical gist of the invention.

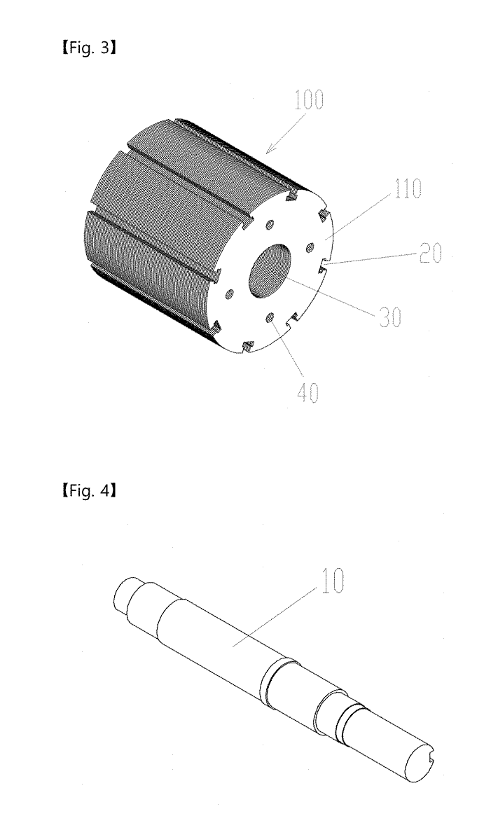

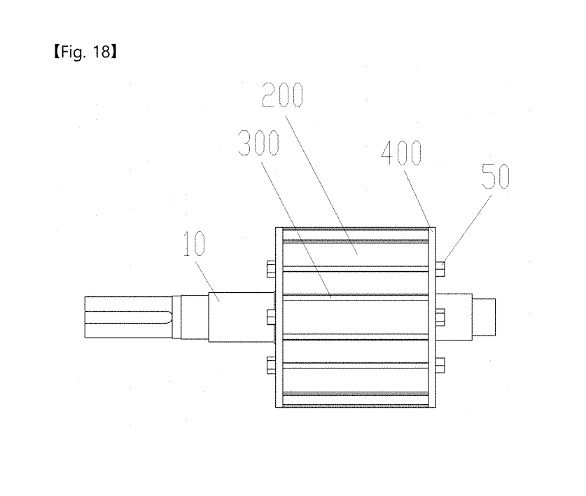

Hereinafter, a rotor of a permanent magnet type which is the invention and its manufacturing method are described in detail in reference to the attached drawings which are FIG. 2˜FIG. 18.

As shown in FIG. 2, a rotor of a permanent magnet type which is the invention includes a rotator core (100) that a rotating axis (10) is combined at the center, several permanent magnets (200) that are placed along with the outer circumference of the above rotator core (100) and several bodies of a jig (300) that fix the above permanent magnet (200) to the outside of a rotator core (100).

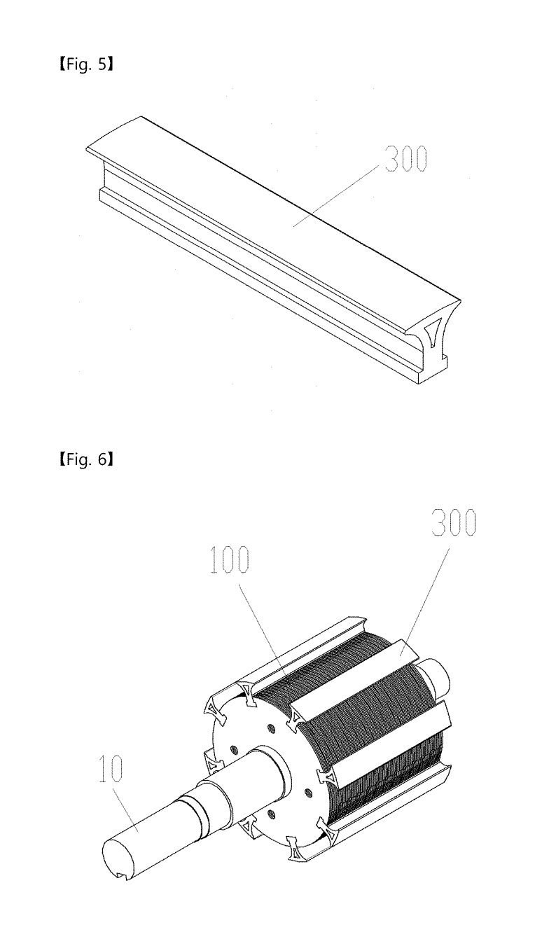

More concretely, the above rotator core (100) is made of a ferromagnetic body such as silicon etc., and as shown in FIG. 3, a fixing groove is formed along with a longitudinal direction. At that moment, a number of the above fixing grooves (20) is formed at a certain interval, and it is desirable to form so that the interval is constant. In addition, as shown in FIG. 4, the above rotator core (100) has an arbor hole at the center so that a rotating axis (10) penetrates and is combined.

The above jig body (300) is made of non-magnetic materials, and for instance, it can be made by die-casting or injection molding of materials such as aluminum, copper, aluminum alloy, stainless steel etc. Besides, since the above jig body (300) is combined by being inserted into a fixing groove (20) forcefully as shown in FIG. 6, it is desirable to form its length so that it can be the same as the length of the above fixing groove (20), but it is not limited to this.

On the other hand, it is desirable to form so that as for a permanent magnet (200) as shown in FIG. 7, the internal curvature has the same curvature as the outer circumference of a rotator core (100), and this permanent magnet (200) is combined and fixed in a type that both sides are wrapped by the above jig body (300) as shown in FIG. 2. In other words, one permanent magnet (200) is inserted forcefully and combined so that both sides are wrapped by two jig bodies (300).

Upon the aforementioned combination between the above rotator core (100) and a jig body (300) and between the above jig body (300) and a permanent magnet (200), welding can be conducted after forceful insertion for a firm fixing.

Since a rotor of a permanent magnet type that is made as above has a permanent magnet (200) that is fixed at the outside of a rotator core (100) by a jig body (300) without using an adhesive, it does not cause a slip phenomenon that a permanent magnet (200) is moved due to a melted adhesive by heat generated during operation of a rotor. Therefore, a rotor of a permanent magnet type by the invention has high safety and high-speed is possible.

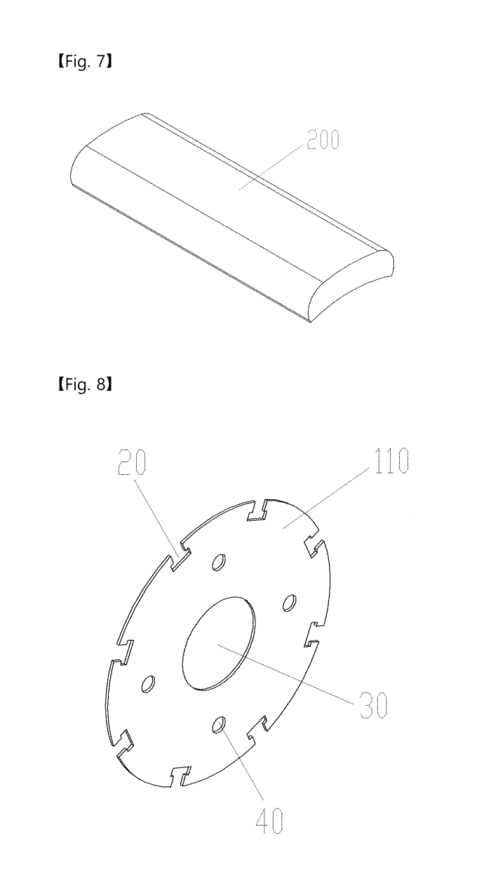

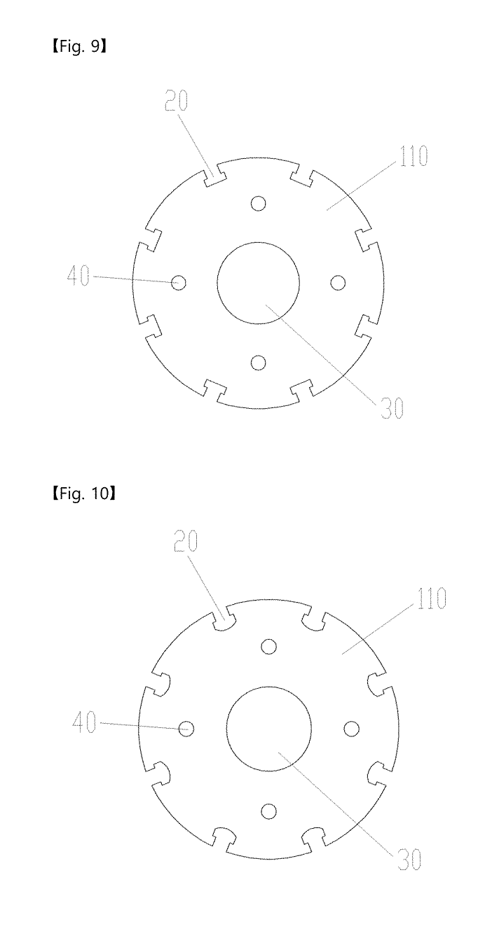

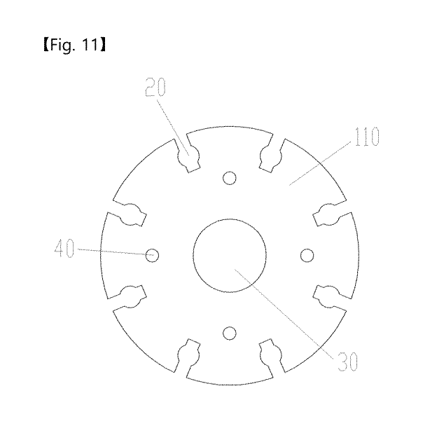

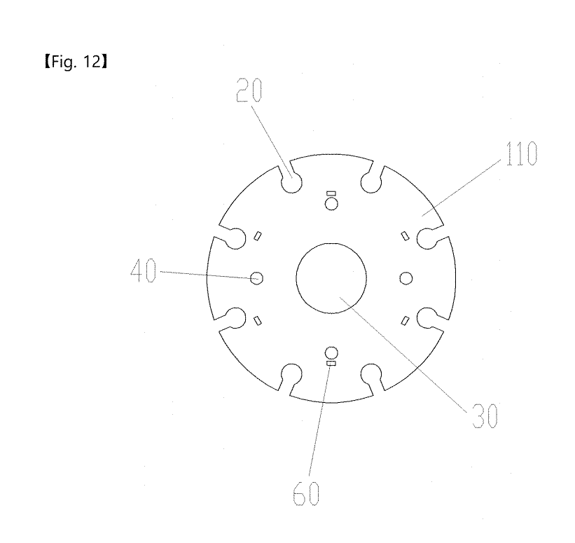

On the other hand, the above rotator core (100) can be formed by accumulation of a number of rotating plates (110) as shown in FIG. 3. The above rotating plate (110) can be made by a stamping method which is a process of using a press, and an arbor hole (30) is formed at the center as shown in FIG. 8 and FIG. 12, and fixing grooves (20) are formed along with the outer circumference.

Besides, a combination hole (40) can be formed between the above arbor hole (30) and a fixing groove (20), and a rotor core (100) can be made to be formed in a state that rotating plates (110) are accumulated by combination of a combination tool (50) with the above combination hole (40)

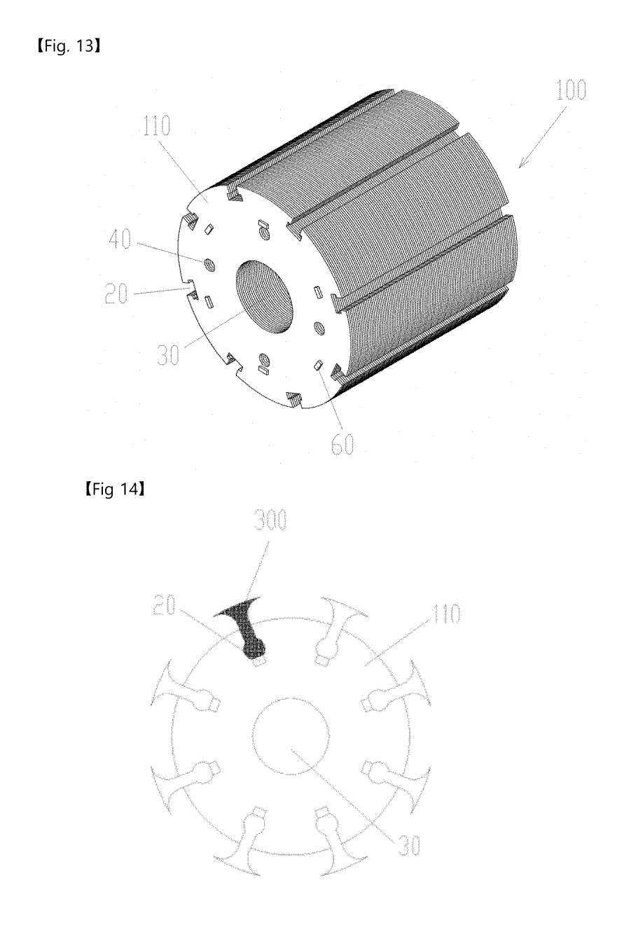

Especially, upon punching blanking (more concretely, high-speed blanking) of the above rotating plate (110), a punching trace (60) can be formed as shown in FIG. 12 and FIG. 13 on the above rotating plate (110). This punching trace (60) forms a bump on one side and a groove on the other side to respond to the above bump by pressurizing a certain part of the rotating plate (110), and multiple rotating plates (110) that have punching traces (60) on the same location are firmly fixed mutually by the punching traces (60) and can create a rotor core (100) as shown in FIG. 13.

Like this, in case of forming a rotator core (100) by accumulating several rotating plates (110), the number of rotating plates (110) forming a rotator core (100) can be adjusted in accordance with quantity of electricity or power quantity that is to be obtained through a generator or a motor using a rotor of a permanent magnet type which is the invention.

Besides, since a silicon steel plate is generally molded and made upon forming a stator, a rotating plate (110) can be made by using the part that is left after making a stator out of the silicon steel plate, and a rotor core (100) can be formed by accumulating the rotating plates (110) that are made in this way so the effects can be acquired that costs are not only saved but also the work speed is improved.

On the other hand, the above fixing grooves (20) can be formed towards an axial direction in a diverse type as shown in FIG. 9 and FIG. 12 on a rotator core (100) or a rotating plate (110), and it is desirable to prevent a body of a jig (300) that is combined with the above fixing groove (20) from being detached upon rotation of a rotor to make the bottom have a wider space than the top.

At this moment, the bottom of the above jig body(300), in other words, the part that is combined with the above fixing groove (20) can be formed so that it can respond to the above fixing groove (20), and for instance, in case that a longitudinal section of the above fixing groove (20) forms the “⊥” shape as shown in FIG. 9, the bottom of the above jig body (300) has the “⊥” shape so that it can respond to a fixing groove (20), and in addition, since the above jig body (300) should wrap the side of a permanent magnet (200), it is desirable to make the entire longitudinal section of a jig body (300) have the “ [symbol] ” shape.

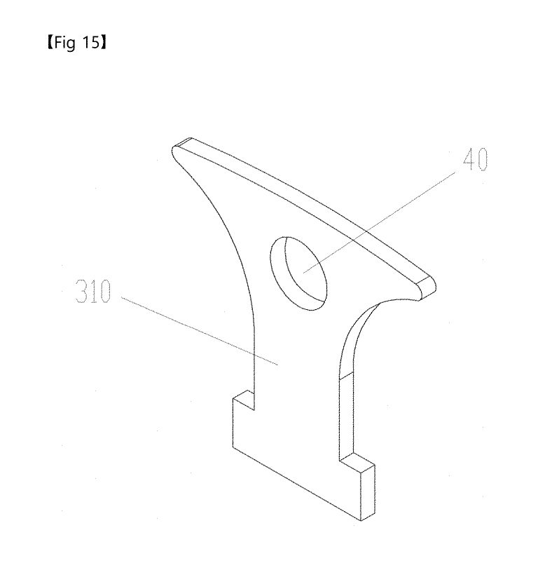

In addition, as shown in FIG. 14, the above fixing groove (20) can be formed so that a space can be formed which is separated from the bottom of a jig body (300) upon combination a jig body (300), and combination between a jig body (300) and a fixing groove (20) can be made more firmly by combining and welding a jig body (300) with a fixing groove (20) through the above separated space.

On the other hand, the above permanent magnet (200) is formed for its both sides to contact a body of a jig (300), and it is desirable for the side contacting a body of a jig (300) to form a curve as shown in FIG. 7. In that case, it can prevent a cogging phenomenon which causes improper operation according to a magnetic field since a load that is imposed on a rotor is too great or voltage and current are too low, and it can obtain an effect of extend a life of a rotor of a permanent magnet type which is the invention since it can minimize noise and vibration.

Besides, as above, in case that the side of a permanent magnet (200) forms a curve, it is desirable for the above jig body (300) to have a curve so that a part contacting a permanent magnet (200) responds to the side of a permanent magnet (200).

Moreover, as shown in FIG. 7, the side of a permanent magnet (200) can have a curve that its slope reduces as it goes from the bottom to the top, and it can be ensured that the above jig body (300) can wrap the entire curve of a permanent magnet (200) as shown in FIG. 5. Due to this, since the above jig body (300) wraps a part of the top as well as the side of a permanent magnet (200), it can prevent a permanent magnet (200) from being detached more effectively upon rotation of a rotor.

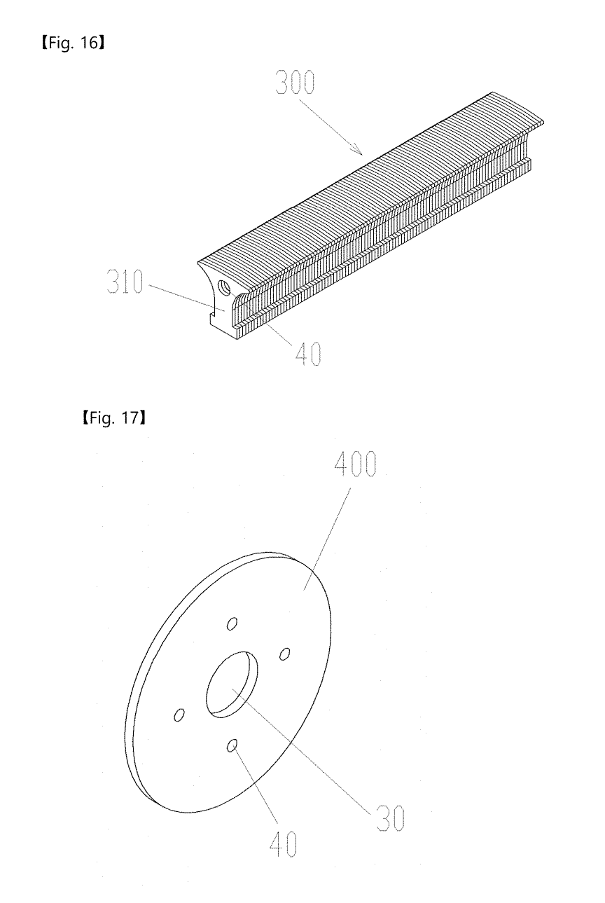

As shown in FIG. 15, the above jig body (300) forms several jig plates (310) and it can be formed by accumulation of them as shown in FIG. 16. In that case, it forms a fixing hole (70) penetrating the above jig plate (310), and jig plates (310) can be fixed mutually and firmly through combination tools (50) penetrating and connecting fixing holes (70) formed on several jig plates (310).

Like this, since a jig body (300) that is formed by accumulation of jig plates (310) can block an eddy current that is created from an alternating field by insulating the gap between jig plates (310), it can not only prevent heating but also save more electric energy.

On the other hand, a rotor of a permanent magnet type which is the invention may include a protective plate (400) as shown in FIG. 17, and the above protective plate (400) is made of non-magnetic materials and an arbor hole is formed for a rotating axis (10) at the center to penetrate, and combination holes (40) can be formed to be combined with a rotator core (100).

The above protective plate (400) can be combined with both ends of the above rotator core (100) as shown in FIG. 18, and at that moment, combination tools (50) are inserted into combination holes (40) and can be fixed firmly with a rotator core (100). Besides, in case that combination holes (40) are formed on the above rotator core (100) like a protective plate (400), it is desirable for combination tools (50) to penetrate at one time and fix a protective plate (400) and a rotator core (100) firmly by forming combination holes (40) of the above protective plate (400) to respond to the location where combination holes (40) of a rotator core (100) are formed.

As for a method of manufacturing a rotor of a permanent magnet by the invention that is described previously, first, a rotating axis (10) is combined at the center and is made of a ferromagnetic material and fixing grooves (20) formed along with a longitudinal direction form a rotator core (100) at a certain interval along with the outer circumference.

At that moment, the above rotator core (100) can be formed by accumulating several rotating plates (110) created by a stamping method focusing on a rotating axis (10), and in that case, since many rotating plates (110) can be produced within a short period of time and it does not need to go through a complicated process, the productivity is improved. Besides, a number of rotating plates (110) can be combined by punching one another.

Next, a body of a jig (300) made of non-magnetic materials is inserted into a fixing groove (20) of the equipped rotator core (100) forcefully for combination, and the above jig body can be formed by accumulating several jig plates (310) created by a stamping method like a rotator core (100).

And then, several permanent magnets (200) are prepared and placed along with the outer circumference of the above rotator core (100) so that both sides can be wrapped by the above jig body (300), and a permanent magnet (200) at that moment can be processed to have a curved side.

In other words, a type of a jig body (300) is determined depending on a type of a permanent magnet (200) and a fixing groove (20).

Lastly, in case that a protective plate (400) is prepared, a rotor of a permanent magnet type is completed by combining the above protective plate (400) with both ends of the above rotator core (100).

Since a rotor of a permanent magnet type can be completed by a method of stamping and punching and simple combination of parts without using a separate adhesive as above, mass production is possible within a short period of time.

### POSITION NUMBER LIST FREE TEXT

10: Rotating Axis

20: Fixing Groove

30: Arbor Hole

40: Combination Hole

50: Combination Tool

60: Punching Trace

70: Fixing Hole

100: Rotator Core

110: Rotating Plate

200: Permanent Magnet

300: Body of Jig

310: Jig Plate

400: Protective Plate

1. In a permanent-magnet typed rotor made by including a rotator core (100) that a rotating axis (10) is combined at the center and that is made of a ferromagnetic material, and several permanent magnets (200) that are placed along with the outer circumference of the above rotator core (100) and several fixing grooves (20) formed along with a longitudinal direction that are formed at a certain interval along with the outer circumference a body of a jig (300) made of non-magnetic materials that are inserted into a fixing groove (20) forcefully, fixing the above permanent magnet, the longitudinal side of
the above jig body (300) is formed in a shape of “ [symbol] ” so that the bottom can respond to the above fixing groove, and the longitudinal side of
the above fixing groove (20) is formed in a shape of “⊥” so that the bottom can have wider space than the top,
but the above rotor core (100) is formed by accumulation of multiple rotating plates (110),
and the above jig body (300) is formed by accumulation of multiple jig plates (310),
and the above fixing groove (20) is a separated space that makes the bottom of the combined above jig body (300) separated and the above jig body (300) fixed to the above core (100) by welding, and a permanent-magnet typed rotor that is characterized by the curved sides of
the above permanent magnet (200) and the above jig body (300) so that they can touch each other and the above jig body (300) that is fixed by wrapping the side of the above permanent magnet (200)

2. In the claim 1,
A rotor of a permanent magnet type which is characterized by the protective plate (400) made of non-magnetic materials at both ends of the above rotor core (100)

3. After a rotating axis (10) is combined at the center and a rotor core (100) that multiple fixing grooves (20) made of soft magnetic materials are formed at a certain interval along with outer circumference is prepared, a step that a jig body (300) made of non-magnetic materials is forcefully inserted and fixed into the above fixing groove (20)
A method manufacturing a permanent-magnet typed rotor that includes a step that multiple permanent magnets (200) are prepared and placed along with outer circumference of the above rotor core (100) so that both sides can be wrapped by the above jig body (300)

4. In the claim 3,
A method manufacturing a permanent-magnet typed rotor that is characterized by including another step that a rotor core (100) is formed by accumulating multiple rotating plates (110) that are created by a stamping method focusing on the above rotating axis (10)

5. In the claim 4,
A method manufacturing a permanent-magnet typed rotor that is characterized by mutual punching combination of the above multiple rotating plates (110)
